(19) United States
(12) Patent Application Publication
(10) Pub. No.: US 2014/0146318 A1
(43) Pub. Date: May 29, 2014

(54) ILLUMINATION APPARATUS AND METHOD FOR OPTIMAL VISION

(71) Applicant: National Taiwan University of Science and Technology, Taipei City (TW)

(72) Inventors: Neng-Chung HU, Taipei City (TW); Chin-Chuan WU, Taipei City (TW)

(73) Assignee: National Taiwan University of Science and Technology, Taipei City (TW)

(21) Appl. No.: 14/073,518

(22) Filed: Nov. 6, 2013

(30) Foreign Application Priority Data
Nov. 28, 2012 (TW) 101144501

(51) Int. Cl. G01N 21/25

(52) U.S. Cl. CPC G01N 21/25
USPC 356/405

(57) ABSTRACT

An illumination apparatus for optimal vision provided in the present invention includes an illumination module, a sensing module, and a computing module. The illumination module is utilized to generate an illuminating light with a plurality of different color temperatures for sequentially illuminating the illuminated object. The sensing module is utilized to sense a reflected light form the illuminated object. The computing module is utilized to calculate a saturation, chorma, and brightness of the illuminated object under the illuminating light by each color temperature, so as to obtain a plurality of preferred values corresponding to the color temperatures of the illuminating light, and for controlling the illumination module to illuminate by the illuminating light with the color temperature corresponding to a maximum among the preferred values. An illumination apparatus for optimal vision is further disclosed.

### CROSS-REFERENCE

This application claims the priority of Taiwan Patent Application No. 101144501, filed on Nov. 28, 2012.

### TECHNICAL FIELD OF THE INVENTION

The present invention relates to an apparatus and method of illumination, and especially to an illumination apparatus and method for optimal vision.

### BACKGROUND OF THE INVENTION

At present, commercially available projection lamps (e.g. halogen lamps, low-color-temperature LEDs, etc) for products have fixed colors and spectrum, but various products require illuminating lights with different colors to represent a best illumination effect. For example, if oranges are illuminated with a low-color-temperature and high-color-rendering light, a more yellowish-orange appearance thereof appears. In addition, lemons appear a more freshly green color under the illumination of a high-color-temperature and high-color-rendering light. Moreover, for example, the illuminating light projected on works of art in a picture gallery, an art gallery, and a museum should have various colors corresponding to different tones of the works, so that a richer color vision appears at the works.

Therefore, a method that the lights emitted from red, blue, amber, and green LEDs are mixed to form a light output with various color temperatures has been proposed. Thus, the color temperature can be modified based on environments or seasons as desired. For example, a warm colored light is used for the illumination in a cold winter.

However, in currently color-temperature-adjustable lamps, the color temperatures are generally controlled by using a wired/wireless remote control. Whether wired or wireless remote control, the color temperatures, the color temperatures are still passively controlled by a human. Furthermore, which color temperature having the optimal vision illumination effect still can not be determined by the manual adjustment. Moreover, the so-called intelligent lighting device at present has no the function of automatically adjusting the color temperatures according to the tones of an illuminated object.

### SUMMARY OF THE INVENTION

Accordingly, an objective of the present invention is to provide an illumination apparatus for optimal vision; the apparatus is capable of automatically selecting an illuminating light which meets the optimal vision for an illuminated object based on human vision.

Another objective of the present invention is to provide an illumination method for the optimal vision; the method is capable of automatically selecting color temperature of illuminating light which meets the optimal vision for the illuminated object based on the human vision.

To achieve the foregoing objective, the present invention provides an illumination apparatus for optimal vision; the apparatus includes an illumination module, a sensing module, and a computing module. The illumination module is utilized to generate an illuminating light with a plurality of different color temperatures for illuminating the illuminated object. The sensing module is utilized to sense a reflected light form the illuminated object for obtaining a set of response values. The computing module is electrically coupled to the sensing module and the illumination module for receiving the set of response values and computing a saturation, a chorma, and a brightness of the illuminated object under the illuminating light by each color temperature according to the set of response values, so as to obtain a plurality of preferred values corresponding to the color temperatures of the illuminating light, and for controlling the illumination module to illuminate by the illuminating light with the color temperature corresponding to a maximum among the preferred values.

In one preferred embodiment, the preferred value is a sum of the saturation, the chorma and the brightness respectively multiplied by three weighted values.

In the preferred embodiment, the sensing module includes a red light sensor, a green light sensor, and a blue light sensor. Specifically, the red light sensor has a spectral sensitivity of 600 nm±20 nm; the green light sensor has a spectral sensitivity of 555 nm±20 nm; the blue light sensor has a spectral sensitivity of 445 nm±20 nm. Moreover, the preferred value is a sum of the saturation, the chorma and the brightness respectively multiplied by three weighted values. Moreover, the weighted value of the saturation is 0.40; the weighted value of the chorma is 0.17; the weighted value of the brightness is 1.66.

In the preferred embodiment, the illumination module includes: a first light-emitting diode (LED) whose main wavelength is 448 nm±20 nm; a second LED whose main wavelength is 505 nm±20 nm; a third LED whose main wavelength is 562 nm±20 nm; and a fourth LED whose main wavelength is 619 nm±20 nm.

To achieve the foregoing objectives, the present invention also provides an illumination method for optimal vision. The method includes steps of: illuminating an illuminated object by an illuminating light with a plurality of different color temperatures; sensing a reflected light form the illuminated object for obtaining a set of response values; computing a saturation, a chorma, and a brightness of the illuminated object under the illuminating light by each color temperature according to the set of response values, so as to obtain a plurality of preferred values corresponding to the color temperatures of the illuminating light; and illuminating by the illuminating light with the color temperature corresponding to a maximum among the preferred values.

In one preferred embodiment, the step of sensing the reflected light form the illuminated object includes simultaneously sensing a red light with a wavelength of 600 nm±20 nm, a green light with a wavelength of 555 nm±20 nm, and a blue light with a wavelength of 445 nm±20 nm. Moreover, the preferred value is obtained by calculating a sum of the saturation, the chorma and the brightness respectively multiplied by three weighted values, and the weighted value of the saturation is 0.40; the weighted value of the chorma is 0.17; the weighted value of the brightness is 1.66.

In the preferred embodiment, the illuminating light with the color temperatures is generated by an illumination module. The color temperatures includes 2700K, 3000K, 3500K, 4000K, 4500K, 5000K, 5700K, 6500K, 9000K, and 12000K. The illumination module includes: a first light-emitting diode (LED) whose main wavelength is 448 nm±20 nm; a second LED whose main wavelength is 505 nm±20 nm; a third LED whose main wavelength is 562 nm±20 nm; and a fourth LED whose main wavelength is 619 nm±20 nm.

In accordance with the apparatus and method for the optimal vision, the saturation, chorma, and brightness of the illuminated object under the illuminating light by each color temperature are calculated according to the set of response values sensed by the red, green, and blue light sensors. The optimal preferred value which mostly meets the human eyes can be calculated based on the three parameters, and the optimal illumination is carried out according to the preferred value obtained from each illuminating light for the illuminated object. Therefore, the drawback that the color temperature can not be automatically adjusted according to the illuminated object in the prior art is overcome; moreover, it can be confirmed the light with the color temperature provides the optimal illumination mostly meeting the human vision.

It is to be understood that both the foregoing general description and the following detailed description of the present invention are exemplary and explanatory and are intended to provide further explanation of the invention as claimed:

### BRIEF DESCRIPTION OF THE DRAWINGS

FIG. 1 is a block diagram illustrating an illumination apparatus for optimal vision according to one preferred embodiment of the present invention;

FIG. 2 is a block diagram illustrating an illumination method for optimal vision according to one preferred embodiment of the present invention; and

FIG. 3 is a flow chart illustrating the steps of comparing the preferred values.

### DETAILED DESCRIPTION OF THE INVENTION

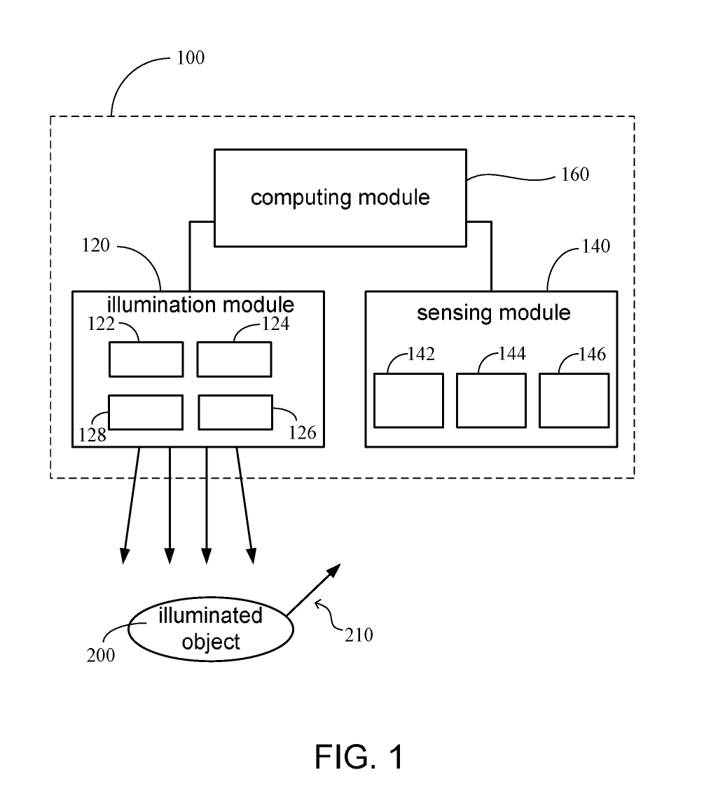

The following will explain the illumination apparatus for optimal vision according to a preferred embodiment of the present invention in detail with drawings. Referring to FIG. 1, FIG. 1 is a block diagram illustrating an illumination apparatus for optimal vision according to one preferred embodiment of the present invention. The illumination apparatus for optimal vision of the embodiment includes an illumination module 120, a sensing module 140 and a computing module 160.

The illumination module 120 is utilized to generate an illuminating light with a high color rendering index and a plurality of different color temperatures for sequentially illuminating an illuminated object 200. As shown in FIG. 1, the illumination module 120 includes a first light-emitting diode (LED) 122, a second LED 124, a third LED 126, and a fourth LED 128. Preferably, The first LED 122, second LED 124, third LED 126, and fourth LED 128 are closely stamped on a same circuit board (not shown), thereby reach a better optical mixing effect. Furthermore, a main wavelength of the first LED 122 is 448 nm±20 nm; a main wavelength of the second LED 124 is 505 nm±20 nm; a main wavelength of the third LED 126 is 562 nm±20 nm; and a main wavelength of the fourth LED 128 is 619 nm±20 nm.

It is worth mentioning that the illuminating light meeting eight color temperatures with color rendering indexes greater than 80 qualified for Energy Star can be generated just by modifying energy distributions of the above-mentioned four LEDs. The qualified color temperature are 2700K, 3000K, 3500K, 4000K, 4500K, 5000K, 5700K, and 6500K, respectively. Moreover, the illumination module 120 of the embodiment is capable of further generating the high-color-temperature illuminating light of 10000K and 12000K for corresponding the illuminated object 200 with chilly tone such as snow, metal, etc. In the embodiment, the illumination module sequentially illuminates the illuminated object 200 in the above-mentioned ten color temperatures. However, the present invention has no limit to amount of the color temperatures to illuminate the illuminated object 200.

The sensing module 140 is utilized to sense a reflected light 210 form the illuminated object 200 for obtaining a set of response values. As shown in FIG. 1, the sensing module 140 includes a red light sensor 142, a green light sensor 144, and a blue light sensor 146. The red light sensor 142 is a sensor sensitive to red light; the green light sensor 144 is a sensor sensitive to green light; the blue light sensor 146 is a sensor sensitive to blue light. Specifically, the red light sensor has a spectral sensitivity of 600 nm±20 nm; the green light sensor has a spectral sensitivity of 555 nm±20 nm; the blue light sensor has a spectral sensitivity of 445 nm±20 nm. The red light sensor 142, the green light sensor 144, and the blue light sensor 146 receive the reflected light 210 from the illuminated object 200 and then respectively generate a set of response values.

The computing module 160 is electrically coupled to the sensing module 140 and the illumination module 140 for receiving the set of response values, and computing a saturation, a chorma, and a brightness of the illuminated object under the illuminating light by each color temperature (2700K, 3000K, 3500K, 4000K, 4500K, 5000K, 5700K, 6500K, 10000K, and 12000K) according to the set of response values, so as to obtain a plurality of preferred values corresponding to the color temperatures of the illuminating light. The computing module 160 calculates approximate tristimulus values by multiplying a RGB-XYZ transformation matrix A and each set of response values. Then the estimated saturation, chorma, and brightness of the illuminated object can be obtained by well-known colorimetry through the approximate tristimulus values. The matrix A is the following equation 1:

$$A = [ \begin{matrix}1.050 & 2.614 & 0.550 \\ 0.479 & 4.597 & - 0.035 \\ 0.0190 & - 0.529 & 7.0296\end{matrix} ] \qquad equation 1$$

It should be noted that the preferred value is a sum of the saturation, the chorma and the brightness respectively multiplied by three weighted values. That is, Wₛ*Suv+W_{c}*Cab+W_{L}*L=the preferred value, in which Wₛ is the weighted value of the saturation, and the weighted value of the saturation is 0.40; W_{c} is the weighted value of the chorma, and the weighted value of the chorma is 0.17; W_{L} is the weighted value of the brightness, and the weighted value of the brightness is 1.66. In addition, Suv is the saturation, Cab is the chorma, and L is the brightness.

In accordance with the above-mentioned calculation of the computing module 160, after obtaining the preferred values corresponding to the ten color temperatures (2700K, 3000K, 3500K, 4000K, 4500K, 5000K, 5700K, 6500K, 10000K, and 12000K), the computing module 160 controls the illumination module 160 to illuminate by the illuminating light with the color temperature corresponding to a maximum among the preferred values. Preferably, the illumination module 160 may includes a control module (not shown) which is capable of dynamically modifying energy distributions of the above-mentioned four LEDs for emitting the illuminating light corresponding to the color temperature. Moreover, the illuminating light corresponding to the maximum among the preferred values has the color temperature meeting the optimal human vision, and has the optimal illumination effect for the illuminated object 200.

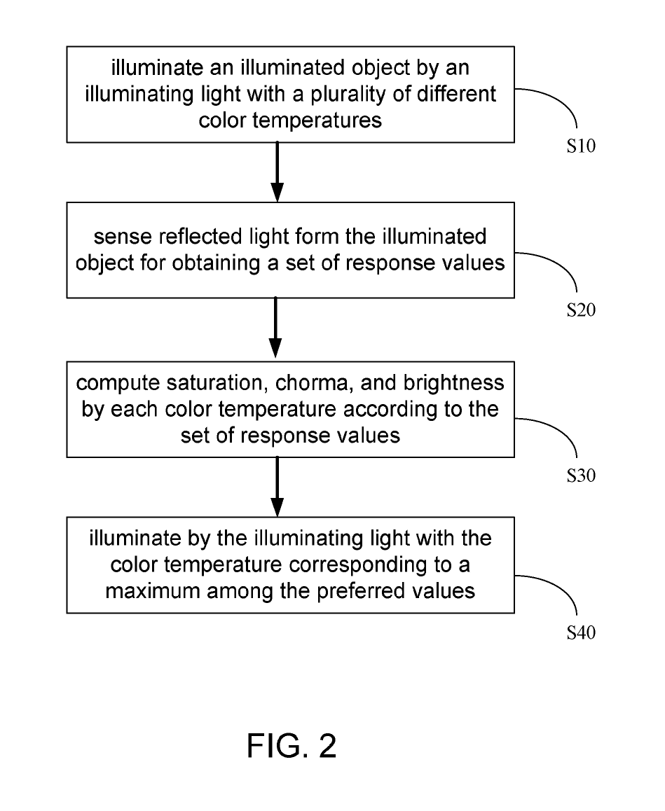

An illumination method for optimal vision by using the above-mentioned illumination apparatus 100 will be explained in detail below. Referring to FIG. 1 and FIG. 2, FIG. 2 is a block diagram illustrating an illumination method for optimal vision according to one preferred embodiment of the present invention. The illumination method for optimal vision begins at step S10.

At step S10, an illuminating light illuminates an illuminated object 200 with a plurality of different color temperatures, and then step S20 is carried out. Specifically, the illumination module 120 is utilized to generate an illuminating light with a plurality of different color temperatures for sequentially illuminating the illuminated object 200. The illuminating light of the color temperatures herein includes 2700K, 3000K, 3500K, 4000K, 4500K, 5000K, 5700K, 6500K, 10000K, and 12000K.

At step S20, a reflected light form the illuminated object is sensed, thereby obtaining a set of response values, and then the step S30 is carried out. Specifically, the step of sensing the reflected light form the illuminated object includes the step of simultaneously sensing a red light with a wavelength of 600 nm±20 nm, a green light with a wavelength of 555 nm±20 nm, and a blue light with a wavelength of 445 nm±20 nm. That is to say, the red light sensor 142, the green light sensor 144, and the blue light sensor 146 receive the reflected light 210 from the illuminated object 200 and then respectively generate a set of response values.

At step S30, a saturation, a chorma, and a brightness of the illuminated object under the illuminating light by each color temperature are computed according to the set of response values, and a plurality of preferred values corresponding to the color temperatures of the illuminating light are obtained, and then the step S40 is carried out. More specifically, the step of the computing module 160 computing the saturation, chorma, and brightness of the illuminated object includes the steps of: (a) calculating approximate tristimulus values by multiplying a RGB-XYZ transformation matrix A and each set of response values; (b) then obtaining the estimated saturation, chorma, and brightness of the illuminated object by well-known colorimetry through the approximate tristimulus values. It should be noted that the preferred value is a sum of the saturation, the chorma and the brightness respectively multiplied by three weighted values, That is, Wₛ*Suv+W_{c}*Cab+W_{L}*L=the preferred value, in which Wₛ is the weighted value of the saturation, and the weighted value of the saturation is 0.40; W_{c} is the weighted value of the chorma, and the weighted value of the chorma is 0.17; W_{L} is the weighted value of the brightness, and the weighted value of the brightness is 1.66. In addition, Suv is the saturation, Cab is the chorma, and L is the brightness.

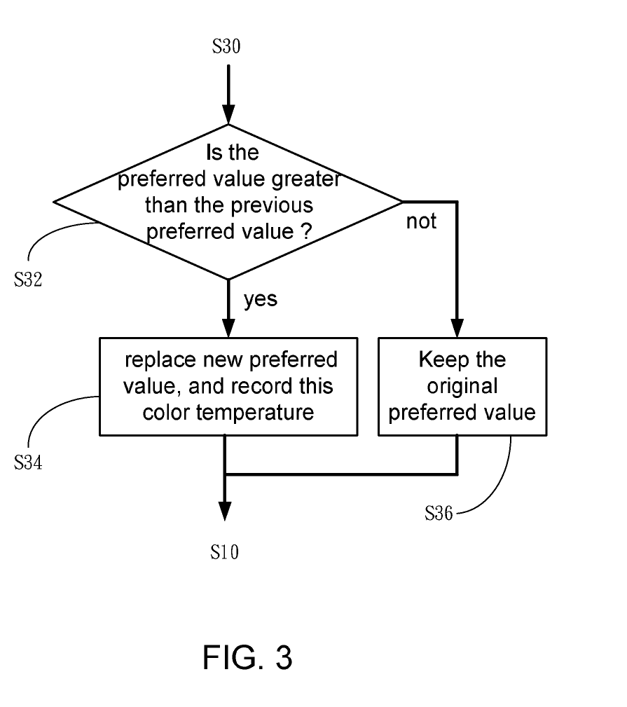

It is worth mentioning that the method further includes the step of comparing the preferred values after step S30 and before step S40. Referring to FIG. 3, FIG. 3 is a flow chart illustrating the steps of comparing the preferred values.

At step S32, the step is to determine the preferred value is greater than the previous preferred value generated from the illuminating light of the previous color temperature, if yes, then carrying out step S43, if not, then carrying out step S36. More specifically, in performing the illuminations by using the illuminating light with the above-mentioned ten color temperatures, the comparing step S32 is carried out at the all illuminations.

At step S34, the new preferred value is replaced, and this color temperature of the illuminating light is recorded. Then the step goes back to step S10 to carry out the illumination of the illuminating light with the next color temperature, thereby comparing the next preferred value.

At step S36, the original preferred value is kept, and then the step goes back to step S10 to carry out the illumination of the illuminating light with the next color temperature, thereby comparing the next preferred value. Finally, the maximum preferred value and the illuminating light with the corresponding color temperature can be obtained. It is worth mentioning that the present invention does not limit the maximum preferred value to be found out in this manner, and it can also be implemented by other manners.

At step S40, the step is to control to illuminate by the illuminating light with the color temperature corresponding to a maximum among the preferred values. In accordance with the above-mentioned calculation of the computing module 160, after obtaining the preferred values corresponding to the ten color temperatures (2700K, 3000K, 3500K, 4000K, 4500K, 5000K, 5700K, 6500K, 10000K, and 12000K), the computing module 160 controls the illumination module 160 to illuminate by the illuminating light with the color temperature corresponding to a maximum among the preferred values. Specifically, the illuminating light corresponding to the maximum among the preferred values has the color temperature meeting the optimal human vision, and has the optimal illumination effect for the illuminated object 200.

In summary, according to the apparatus and method for the optimal vision, the saturation, chorma, and brightness of the illuminated object under the illuminating light by each color temperature are calculated according to the set of response values sensed by the red, green, and blue light sensors. The optimal preferred value which mostly meets the human eyes can be calculated based on the three parameters, and the optimal illumination for the illuminated object is carried out according to the illuminating light with the color temperature corresponding to the maximum preferred value. Therefore, the drawback that the color temperature can not be automatically adjusted according to the illuminated object in the prior art is overcome; moreover, it can be confirmed the light with the color temperature provides the optimal illumination mostly meeting the human vision.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. An illumination apparatus, comprising:
an illumination module for generating an illuminating light with a plurality of different color temperatures for illuminating an illuminated object;
a sensing module for sensing a reflected light form the illuminated object for obtaining a set of response values; and
a computing module electrically coupled to the sensing module and the illumination module for receiving the set of response values and computing a saturation, a chorma, and a brightness of the illuminated object under the illuminating light by each color temperature according to the set of response values, so as to obtain a plurality of preferred values corresponding to the color temperatures of the illuminating light, and for controlling the illumination module to illuminate by the illuminating light with the color temperature corresponding to a maximum among the preferred values.

2. The illumination apparatus of claim 1, wherein the preferred value is a sum of the saturation, the chorma and the brightness respectively multiplied by three weighted values.

3. The illumination apparatus of claim 1, wherein the sensing module includes a red light sensor, a green light sensor, and a blue light sensor.

4. The illumination apparatus of claim 3, wherein the red light sensor has a spectral sensitivity of 600 nm±20 nm; the green light sensor has a spectral sensitivity of 555 nm±20 nm; the blue light sensor has a spectral sensitivity of 445 nm±20 nm.

5. The illumination apparatus of claim 4, wherein the preferred value is a sum of the saturation, the chorma and the brightness respectively multiplied by three weighted values, and the weighted value of the saturation is 0.40; the weighted value of the chorma is 0.17; the weighted value of the brightness is 1.66.

6. The illumination apparatus of claim 1, wherein the illumination module comprises:
a first light-emitting diode (LED) whose main wavelength is 448 nm±20 nm;
a second LED whose main wavelength is 505 nm±20 nm;
a third LED whose main wavelength is 562 nm±20 nm; and
a fourth LED whose main wavelength is 619 nm±20 nm.

7. An illumination method, comprising steps of:
illuminating an illuminated object by an illuminating light with a plurality of different color temperatures;
sensing a reflected light form the illuminated object for obtaining a set of response values;
computing a saturation, a chorma, and a brightness of the illuminated object under the illuminating light by each color temperature according to the set of response values, so as to obtain a plurality of preferred values corresponding to the color temperatures of the illuminating light; and
illuminating by the illuminating light with the color temperature corresponding to a maximum among the preferred values.

8. The illumination method of claim 7, wherein the step of sensing the reflected light form the illuminated object comprises simultaneously sensing a red light with a wavelength of 600 nm±20 nm, a green light with a wavelength of 555 nm±20 nm, and a blue light with a wavelength of 445 nm±20 nm.

9. The illumination method of claim 8, wherein the preferred value is obtained by calculating a sum of the saturation, the chorma and the brightness respectively multiplied by three weighted values, and the weighted value of the saturation is 0.40; the weighted value of the chorma is 0.17; the weighted value of the brightness is 1.66.

10. The illumination method of claim 7, wherein the illuminating light with the color temperatures is generated by an illumination module, the color temperatures comprising 2700K, 3000K, 3500K, 4000K, 4500K, 5000K, 5700K, 6500K, 9000K, and 12000K, the illumination module comprising:
a first LED whose main wavelength is 448 nm±20 nm;
a second LED whose main wavelength is 505 nm±20 nm;
a third LED whose main wavelength is 562 nm±20 nm; and
a fourth LED whose main wavelength is 619 nm±20 nm.
